(19) United States
(12) Patent Application Publication
(10) Pub. No.: US 2026/0133319 A1
(43) Pub. Date: May 14, 2026

(54) SYSTEM FOR NAVIGATING IN CAVITIES

(71) Applicant: Moshe ORE, Alfei Menashe (IL)

(72) Inventor: Moshe ORE, Alfei Menashe (IL)

(21) Appl. No.: 19/443,296

(22) Filed: Jan. 8, 2026

Related U.S. Application Data
(63) Continuation of application No. 17/889,799, filed on Aug. 17, 2022.

(51) Int. Cl. G01S 17/89; G01S 7/481; G01S 19/49; G05D 1/00; G06T 17/05

(52) U.S. Cl. CPC G01S 17/89; G01S 7/4817; G01S 19/49; G06T 17/05

(57) ABSTRACT

A system, apparatus and method for mapping and navigating within a cavity lacking continuous satellite visibility, the system comprising: a scanning device configured to generate a spatial model of the cavity using a simultaneous localization and mapping (SLAM) module; a localization module configured to obtain absolute position information when available; an inertial measurement unit (IMU) for providing data of motions taken by a user using the system; at least one processor configured to: receive the absolute position information from the localization module; receive the spatial model generated by the SLAM module; associate relative SLAM coordinates of the scanning device with the absolute position information; update locations within the spatial model based on the motion data; and a wearable device comprising a display device, the display device adapted to display a presentation of at least a part of the spatial model or a map of the cavity.

### CROSS-REFERENCE TO RELATED APPLICATIONS

The present application is a continuation of and claims priority from U.S. patent application Ser. No. 17/889,799, filed Aug. 17, 2022, entitled “A SYSTEM FOR NAVIGATING IN CAVITIES” which is incorporated herein by reference.

### TECHNICAL FIELD

Embodiments of the disclosure relate to mapping areas in general, and to creating and using models of cavities, the models comprising real world coordinates, in particular.

### BACKGROUND

Navigation in different areas, even for a first time in an unknown area has become significantly easier since Global Positioning Systems (GPS) and Global Navigation Satellite System (GNSS) have been introduced and became widely available. As for mapping spaces and navigating therein, methods and devices exist such as accelerometer measurements, cameras, Wi-Fi networks, or the like. Real-world coordinates within indoor areas can be obtained by combining GPS locations with these techniques. Such relation is particularly required for tasks that involve the real-world coordinates and the internal space.

However, the available methods are limited in their abilities and accuracy. Further, the inaccuracies increase as the distance from the cavity entrance increases. Moreover, such solutions cannot be used for navigating within a new unexplored area, particularly when the area is complex, for example contains twisted corridors, turns, intersections, smaller cavities or the like, such as a tunnel system, a mine, or the like. Further complications may arise when the area is dark. Using flashlight or another light source may help, but does not solve the problem completely, since such a light source can also create confusing shadows in such environment, and is limited in its intensity and/or illumination direction.

Yet another issue is that a person exploring such areas needs to be cautious and may need to use his hands, for not colliding with walls or objects, protecting his head, holding one or more objects such as a flashlight, a weapon, or the like.

### BRIEF SUMMARY

One exemplary embodiment of the disclosed subject matter is a system, comprising: a scanning or measuring device for obtaining information about a cavity surrounding a user, the scanning or measuring device comprising a localization and mapping device, wherein the scanning or measuring device is adapted to register a first location of the scanning or measuring device relative to the cavity after the system is stationary for at least a predetermined period of time, said registration being associated with a first time stamp; a device for providing location information; one or more first processors adapted to: obtain an absolute location of the system from the device for providing location information when the system is stationary for at least the predetermined period of time; and register the absolute location in association with a second time stamp; one or more second processors adapted to: receive the information collected by the scanning or measuring device and generate a model of the cavity based on the information; and match the absolute location from the device for providing the location services with the location of the scanning or measuring device, based at least on the first time stamp and the second time stamp; and a display device adapted to display to the user a representation of the model of the cavity, the representation comprising an indication the first location with the associated absolute location. Within the system, the first processor, the second processor, the device providing location information and the scanning or measuring device are optionally located in a housing. Within the system, the first processor, the device providing location information and the scanning or measuring device are optionally located in a housing, and the second processor is optionally located in a mobile operation interface not included in the housing. Within the system, the representation may further comprise an indication of a second location within the model, and associated absolute locations. Within the system, the second location is optionally indicated in a less prominent manner than the first location. Within the system, the predetermined period of time is optionally between about 0.5 seconds and about 30 seconds. Within the system, the display device is optionally further adapted to receive from the user an indication to an area of the cavity, and display an image captured by the image capture device depicting the area. Within the system, the scanning or measuring device and the device providing location information are optionally adapted to be attached to one or more wearable items, thereby enabling the user to advance with free hands within the cavity. Within the system, the wearable item optionally comprises one or more items to which the display device attaches, the one or more items selected from the group consisting of: a wrist case, a vest, glasses; and a helmet. Within the system, the wearable item optionally comprises a vest to which the scanning or measuring device attaches. The system can further comprise a data storage device for storing data output by the scanning or measuring device and images captured by the image capture device. Within the system, the data storage device is optionally adapted to be attached to a wearable item. The system can further comprise a communication module for transmitting information collected by the scanning or measuring device to a remote computing device. Within the system, the remote computing device is optionally adapted to generate a three dimensional model of the cavity. Within the system, the information is optionally three dimensional, and the system can further comprise a processor for determining a projection of the three dimensional information onto a two dimensional map. The system can further comprise a frame wherein the scanning or measuring device, the image capture device and the device providing location information are attached to the frame. Within the system, matching the absolute with the location of the scanning or measuring device, is optionally based also on relation between the absolute location and the location.

Another exemplary embodiment of the disclosed subject matter is an apparatus, comprising: a base device of a system for providing location information; a moving platform having installed thereon: a scanning or measuring device for obtaining information about a cavity surrounding the moving platform, the scanning or measuring device comprising alocalization and mapping device, wherein the scanning or measuring device is adapted to register a first location of the scanning or measuring device relative to the cavity after the system is stationary for at least a predetermined period of time, said registration being associated with a first time stamp; a rover device in communication with the base device; at least one first processor adapted to: obtain an absolute location of the system from the rover device when the system is stationary for at least the predetermined period of time; and register the absolute location in association with a second time stamp; a second platform having installed thereon: a second processor adapted to: receive the information collected by the scanning or measuring device and generate a model of the cavity based on the information; and match the absolute location received from the device for providing location information with the first location according to the first time stamp and the second time stamp; and a display device adapted to display to the user a representation of the model of the cavity, a route taken by the moving platform within the cavity and an indication of the first location with the associated absolute location. Within the apparatus, the moving platform is optionally remotely stirred in accordance with the information as received at the remote computing platform.

Yet another exemplary embodiment of the disclosed subject matter is a method comprising: receiving from a scanning or measuring device information about a cavity, the scanning or measuring device comprising a localization and mapping device; receiving from the scanning or measuring device a first location of the scanning or measuring device relative to the cavity after the scanning or measuring device is stationary for at least a predetermined period of time, the first location being associated with a first time stamp; generating a model of the cavity based on the information; and receiving from a device for providing location information, absolute coordinates after the device for providing location information is stationary for at least the predetermined period of time, said absolute coordinates associated with a second time stamp; matching the first location of the scanning or measuring device with the absolute coordinates according to the first time stamp and the second time stamp; and displaying to a user a view of the model and an indication of the first location with the associated absolute location.

### BRIEF DESCRIPTION OF THE SEVERAL VIEWS OF THE DRAWINGS

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below.

FIG. 1 shows a schematic functional block diagram of a system, in accordance with some exemplary embodiments of the disclosure;

FIG. 2 shows a schematic illustration of a carried device, in accordance with some exemplary embodiments of the disclosure;

FIG. 3A shows a side view of carried device without Global Navigation Satellite System (GNSS) rover and without a frame, in accordance with some exemplary embodiments of the disclosure;

FIG. 3B shows a user holding the device by s handle with the scanner and the capture device attached to a holder, in accordance with some exemplary embodiments of the disclosure;

FIG. 3C shows an illustration of an exemplary wearable item being a wrist case for holding the display device, in accordance with some exemplary embodiments of the disclosure;

FIG. 4 shows an illustration of wearable item being a vest, to which the scanning device attaches, in accordance with some exemplary embodiments of the disclosure;

FIG. 5 shows the control and data transfer between the system units, and the relevant protocols, in accordance with some exemplary embodiments of the disclosure;

FIG. 6A shows an illustration of an exemplary two dimensional view of the cavity and the user's route therein, in accordance with some exemplary embodiments of the disclosure;

FIG. 6B shows a user interface of a system for mapping a cavity, when a user is static, in accordance with some exemplary embodiments of the disclosure;

FIG. 6C shows a user interface of a system for mapping a cavity, when a reference point has been taken, in accordance with some exemplary embodiments of the disclosure;

FIG. 6D shows a user interface of a system for mapping a cavity, showing reference points with their respective absolute coordinates, in accordance with some exemplary embodiments of the disclosure;

FIG. 7A shows an exemplary 3D model of an underground tunnel system, in accordance with some embodiments of the disclosure;

FIG. 7B shows a map comprising a projection model of a cavity on the ground level, and objects in the vicinity of the cavity, in accordance with some embodiments of the disclosure;

FIG. 8A is an image of a side view of a demolished building;

FIG. 8B is a side view of the 3D model of the demolished building of FIG. 8A, in accordance with some embodiments of the disclosure; and

FIG. 9 is a flowchart of steps in a method for providing display of a cavity, that may be performed by a processor of the carried device a processor of additional device, or a combination thereof, in accordance with some embodiments of the disclosure.

### DETAILED DESCRIPTION

The term “cavity” used in the disclosure is to be widely construed to cover any space to be scanned, explored or investigated, whether partly or fully closed, partly or fully unseen from the outside, above or below the ground, or the like. A cavity may contain objects therein, such as walls, furniture or moveable items.

The terms “a device providing location information”, a Real-Time Kinematic (RTK) device, a Global Navigation Satellite System (GNSS) device, a Global Positioning System (GPS), or similar terms, technologies or services are used interchangeably in the disclosure, for purpose of providing accurate location. The device may be standalone, a rover device carried into the cavity and being in communication over any communication channel such as a SIM card, radio, or others, with a base station or with a base device. In some embodiments, locations may be obtained from other devices, such as manual devices, optical devices or the like.

One technical problem handled by the disclosure relates to navigating within cavities or internal spaces, which may or may not have a line of sight to satellites, and therefore may or may not use Global Navigation Satellite System (GNSS) such as Global Positioning Systems (GPS). Such cavities may include natural cavities such as caves, as well as manmade cavities such as mines, tunnel systems, or the like. In particular, dark and complex cavities, for example cavities comprising junctions, twisted or branched corridors, objects located within the space, or the like, may cause even an experienced navigator to lose track of where he is in the complex, what areas have and have not been explored, how to move forward, and how to get to an exit. Another example of areas to be explored may include wrecked buildings or objects, such as building collapsed due to earthquakes or other reasons. GPS reception may be available in some part of these areas, while in others it may not. Either way, it may be required to move within the spaces looking for survivors. Naturally, no mapping exists for such structures in their demolished state, while on the other hand, time is of essence and it is required to act fast and scan the cavities efficiently.

In some embodiments, it may be important to know the accurate real-world coordinates of locations within the cavity. In other situations, it may be required to drill down into a specific location within the cavity, therefore it is highly important to have the exact location to ensure accurate access, otherwise digging may lead to a dead end, to a wall, to a dangerous area, or the like.

Another technical problem relates to obtaining and maintaining reliable data about the structure of the cavity as captured, including walls, corridors, ceiling, furniture, objects therein or others, also after mapping is completed. The maintained data can then be used for planning near and far future activities, realizing areas that have not been fully explored, determining access ways to the cavity, or the like.

Yet another technical problem relates to associating locations within the cavity with real world coordinates. Such technical problem may arise, for example, when it is required to drill from the surface into a cavity such as a mine or a tunnel, or from a lower underground level to a higher one in order to access a specific area thereof. Digging in the wrong location may lead to a dead end within the cavity, a wall, a dangerous area, or the like. Further activities may require a combined map, which comprises over-ground and underground data of an area, for example showing the projection of the space relatively to surface objects in the area, such as houses. This structure may be used to determine existing access ways to the underground cavities, for planning activities in the area, or planning new access ways. One particular use relates to mapping of a structure, such as a building, a bridge, a wall, or the like, wherein said mapping comprise absolute coordinates. Yet another situation is when a cavity explorer needs to find an entry or an exit to or from the cavity, but also needs to know where the entry or exit are in the real world, for example in order to coordinate a ride.

Another technical problem handled by the disclosure is that it may be required to enable an explorer of a cavity to move hands-free within the cavity, such that he can walk through narrow openings or corridors, and use his hands for other purposes such as stabilizing, protecting himself, holding other objects, or the like.

The discussion below uses interchangeably the terms “cavity”, “area”, “non-exposed area” and “internal space” to relate to areas, wherein locations within the area do or do not have line of sight to satellites or other devices, and wherein the locations are underground or above ground.

One technical solution comprises a system including a carried device, and an interface device, such as a Mobile Operator Interface (MOI), wherein a user may carry one or both devices inside the cavity or to a location from which there is a line of sight into the cavity. The carried device may comprise a scanner or measuring device for mapping cavities, such as a localization and mapping device and in particular Simultaneous Localization and Mapping (SLAM) device. In some embodiments, the SLAM device may generate a cloud of points, for example 40,000 points per second, which provide a two dimensional or three dimensional outline of the part of the cavity and the objects therein to which there is a line of sight. The system may further comprise an inertial measurement unit (IMU) for analyzing the route the user is traversing within the cavity and determining relative locations within the cavity. In some embodiments of the disclosure, the system may also comprise a GNSS device, wherein the carried device may comprise the rover member of a GNSS system, while the base member of the GNSS system may be located elsewhere, for example at or near the entrance to the cavity or at another location having a line of sight to satellites, or at a point whose coordinates have been determined earlier.

In some embodiments of the disclosure, a user may carry the carried device by hand. However, the carried device may additionally or alternatively be adapted to be secured to a wearable item the user is wearing, such as a vest. In some embodiments, the MOI may be secured to the user's wrist, similarly to a watch, such that the user can look at his wrist in the same way a person is looking at his watch, and see a model of the cavity, his route within the cavity, and optionally additional information. In other embodiments the MOI may be attached to a helmet, cap, glasses, or the like.

The system may also comprise additional components such as a data logger which may be a storage device adapted to log the data collected by the scanning or measuring device such as the point cloud and other data produced or obtained by the SLAM, and/or the IMU readings; a battery pack; an image capture device, or others, which may also be fitted on the vest or otherwise carried by the user.

In some embodiments, the user may carry the carried device in his hand or have it attached to the user's helmet, cap, glasses, or the like, and reach out into an opening. The user can then look at the MOI and view the opening structure and images, to determine whether the opening leads in a direction worth exploring, or is a dead end, and there is no need to attempt to advance in that direction.

The capture device may capture images which may also be stored within the data logger. Each such image may be associated with a time stamp and/or with a relative or absolute location within the cavity. On future explorations of the cavity, as a user advances within the cavity, images relevant for each location may be retrieved, such that the user can compare the retrieved images to the current view in order to make sure he is on the right place, determine whether changes have occurred, or the like. The images may also be used by another user examining the model.

The system may enable the user to explore the cavity and receive a visual description of the cavity structure and the user's route as obtained from the SLAM and the IMU, for example over the MOI, wherein the visual description develops as the user advances. The visual description is particularly important in dark or complex areas, and for enabling the user to determine areas he would like to explore further, turns he would like to take, find his way out, or the like.

Another technical solution comprises accurate determination of a location of the device at selected points within the cavity, prior to entering the cavity, and/or at locations in which the rover has a line-of-sight to satellites or to known points. The GNSS rover, with data received from the GNSS base, can acquire and note the exact absolute location of the GNSS rover and hence of the system, at the time. Thus, if the user has stopped and the system is stationary for at least a predetermined period of time, for example between five seconds and fifteen seconds, such as ten seconds, and the GNSS rover has line of sight to satellites, the system can be adapted to acquire and note the exact absolute location, for example with a deviation of between a few millimeters and a few meters. Additionally, at these times when the user has stopped, the mapping device may also register its location within the cavity, for example relative to the cloud of points it generates at the location. The absolute locations, as obtained by the GNSS rover can then be matched with the relative locations within the cavity as obtained by the mapping device using the corresponding time stamps, thereby associating locations within the cavities with absolute coordinates. Matching may also use the relation between the locations, for example matching may be performed only if the locations are at most a predetermined distance away from each other, wherein the predetermined distance may depend on the accuracy of each device, are compliant with previous locations by each of the devices, or the like. The location may thus be derived by the relation between the read points and also their relative locations within the cavity. This association enables improved access to locations within the cavity, whether by advancing within the cavity, or by accessing from the outside, for example drilling into the cavity. Detecting that the user has stopped may also be performed by analyzing the IMU data of the system. The mapping device may, too, recognize the stopping times based on an internal IMU, external signals received from the system IMU, or the like.

In some embodiments, when it is recognized that the user has stopped, one or more images of the scene may be automatically captured and associated with the location as well.

Once accurate locations for one or more points (referred to as marked points) are available, the locations of intermediate points between the points for which the absolute locations are obtained may be assessed. The locations of the intermediate points may be assessed based on the available absolute locations of the marked points, and the accumulated changes in the user's location as obtained and calculated from the reports by the IMU and/or the SLAM. For example, the location may be obtained every predetermined period of time for example 10 seconds, one minute, or the like, or after the device is at a location for at least a predetermined period of time and does not move, for example for 10 seconds, even if the system does not have line of sight to satellites when the points are taken. However, the exact known locations of the marked points may improve the accuracy for other points or areas within the model.

The obtained locations may then be stored and associated with the relevant data taken at that time, for example the point cloud provided by the SLAM, the location provided by the IMU, the images, or the like, such that some locations or points in time may be associated with a known location.

Yet another technical solution comprises the usage of the obtained structure, also referred to as model, for further exploration of the cavity, especially with the route of a new exploring user being marked on the existing structure. The locations of the marked points may be specifically indicated with their coordinates on one or more representations thereof.

The system may further comprise one or more remote interfaces, such as one or more local operator interface (LOI) positioned, for example, near the entrance to the cavity, and/or one or more commander operator interface (COI) located anywhere. The remote interface may or may not be stationary, at least for the duration of exploring the cavity. The remote interfaces may display the structure of the cavity and the user's route therein as uncovered during the user's advancement, or the complete structure of the cavity, images captured by the capture device, absolute or relative locations, or the like. In particular, the coordinates of the marked points may be displayed as well. It will be appreciated that the data may be displayed at a later time, after the user has exited the cavity, and if the system is in communication with any of the remote interfaces, then also in real time or near real time as the user is exploring the cavity. The cavity structure may be displayed in two dimensions (2D) or three dimensions (3D) and may be used for planning operations such as planning how to use the cavity, distances, access ways, or the like.

One technical effect of the disclosure is providing a hands-free navigation system for exploring a cavity, such that the user's hands remain free for other needs. The user can see a model of the area he is currently at, as well as areas he has previously been at, the route he took, additional turns to be considered, and the way to an exit.

Another technical effect of the disclosure is that since the structure of the cavity and the route are displayed on a display device, such as the LOI, the user can navigate within the cavity in the dark, without having to turn on additional light, thus avoiding being discovered, disturbing animals, hitting walls or other objects, or the like. The user can thus advance or backtrack in the dark according to the shown structure.

Yet another technical effect of the disclosure is the online and offline availability of the obtained structure, for current and further planning of further actions or explorations.

Yet another technical effect of the disclosure is that real world coordinates of locations and objects within the cavity, such as the marked points are known with high accuracy, which may also improve the accuracy of other locations within the cavity. The locations, expressed for example as points in a projection of the cavity on a two dimensional map of the area, possibly with depth information, enable the planning of accurate access to the cavity from above or form another direction for various needs. The presence of points whose coordinates are known, provide for more accurately noting additional locations on the projection with their coordinates, thereby enabling access or other operations.

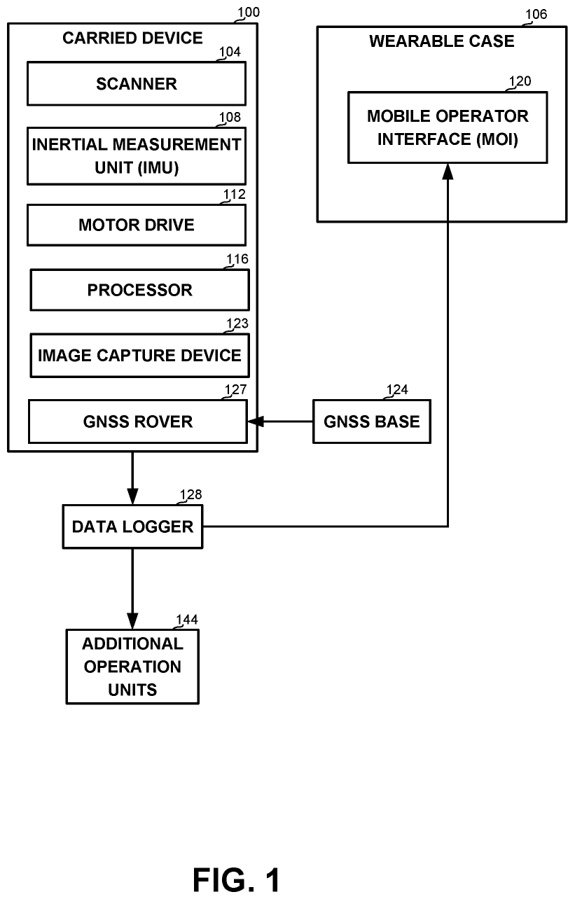

Referring now to FIG. 1, showing a schematic functional block diagram of a system in accordance with the disclosure.

The system may comprise carried device 100, which a user may carry by hand, or attach to a wearable item such as a vest. Carried device 100 may also be carried by a drone, a robot, a small vehicle or an animal back, or the like. The system may further comprise a mobile operator interface (MOI) 120, which may be set within a wearable case 106, such as a wrist case, mounted on the user's head, connected to glasses, helmet, a vest, or the like.

The system may further comprise a data logger 128 for collecting data from carried device 100, store it and optionally provide it to other components, such as MOI 120 for display. The data may also be provided to additional operation units 144, such as LOI, COI, or the like. Data logger 128 may also be attached to a wearable item of the user, or carried upon a drone, a small vehicle, an animal back, or the like.

In some embodiments, processor 116 of carried device 100 or a processor of MOI 120 may generate a model, such as a two-or three-dimensional model of the cavity, upon the raw data received, directly or indirectly, from scanner 124. MOI 120 may then display to the user, in real time or near real time a view of the model. MOI 120 may then display to the user additional information, such as intelligence-related information received from a remote source. The information, provided to MOI 120, determined by MOI 120, stored within the data logger, or the like, may also be transmitted to remote locations, such as LOI, COI or others.

Additional operation units 144 may also receive the raw data, in real time or at a later time, and may generate a three dimensional model of the cavity, and display a view or a projection of the three dimensional model on a display device of the LOI, COL, or any another display device. The information may be displayed with images, exact location as described above, or the like.

The system may further comprise GNSS base member 124, for determining exact absolute location, for example by receiving signals from 3-5 satellites.

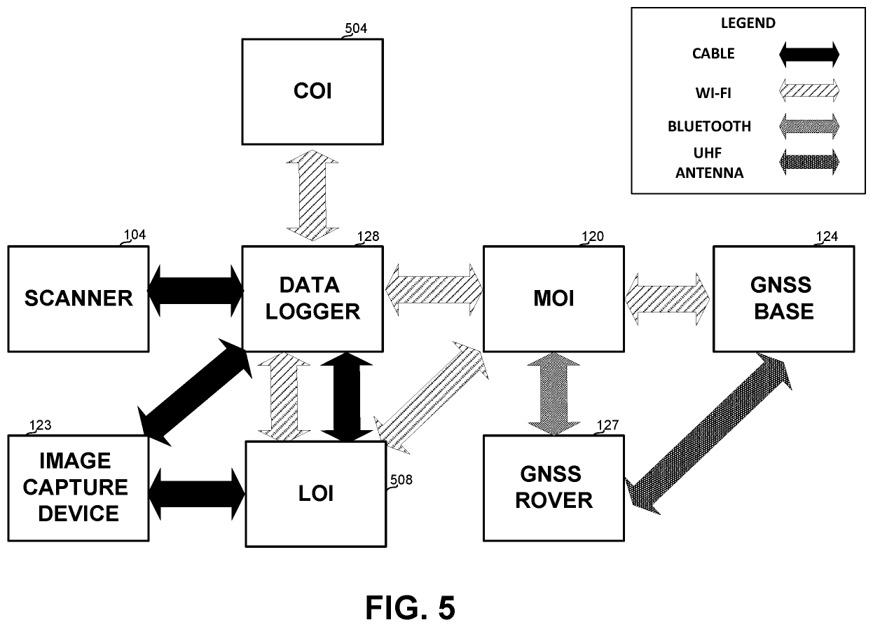

The communication routes and protocols are further detailed in association with FIG. 5 below.

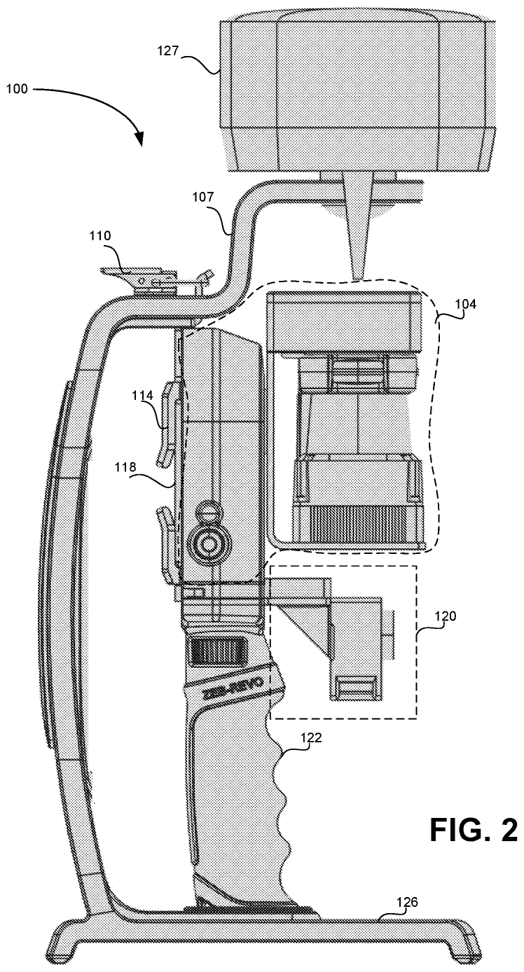

Referring now also to FIG. 2 showing a schematic illustration of carried device 100.

Carried device 100 may comprise a scanner or measuring device 104, which may be a SLAM device for obtaining the structure of a cavity the user is in. The SLAM device can use the point cloud technique to depict the objects in its vicinity, including for example walls, corridors, openings, stairs, floor, pits, ceilings, and objects within the cavity. One example for such device is GeoSlam by Bingham, Nottinghamshire, UK. The SLAM device may scatter a multiplicity of laser beams, for example at least 40,000 beams per second each hitting the nearest object in its direction, receive the returned signals, compute the distance to the object in that direction, and thereby obtain a model of the area. Scanner 104 may be adapted to note, for example through an internal IMU or any other mechanism that the system is stationary. Scanner 104 may then set a timer, and if the user has stopped for at least a predetermined period of time, mark the current location of the device within the cloud of points. The location may be associated with a time stamp. The predetermined period of time may be between about 0.5 seconds and about 30 seconds, for example 10 seconds when scanning is done while a user is walking, 0.5-1 seconds when a user or the system are flying, or the like.

Carried device 100 may comprise an IMU 108. Scanner 104 and IMU 108 may be functionally, electronically and/or mechanically coupled, and in some embodiments, IMU 108 may be embedded within scanner 104. In some embodiments, carried device 100 may comprise a first IMU 108, and a second IMU (not shown) within scanner 104. Carried device 100 may comprise a motor drive 112 for rotating scanner 104 such that the point cloud spreads in all directions around scanner 104 and is not limited to certain directions. Scanner 104 may be rotated continuously by motor drive 112, and as it is being rotated and also moved due to the movement of the user, the area is continuously mapped and a model of the traversed area may be constructed based on the point cloud.

IMU 108 may be any motion sensor, for example an accelerometer. Upon analysis of the measures provided by IMU 108, the advancement of the user within the cavity may be assessed and combined with the measures taken by scanner 104, to provide the user's location at any given time relative to the cavity structure.

Carried device 100 may further comprise processor 116 for processing and integrating the scanning results. Processor 116 may be embedded within scanner 104 or IMU 108. In other embodiments, processor 116 may be external to scanner 104 and IMU 108, and may receive and integrate further information such as images. In further embodiments, processor 116 may be implemented as two or more processors, for example one or more processors within scanner 104, and one or more additional processors for integrating the readings with additional data such as relative or absolute coordinates, building a model of the cavity, and displaying the model and optionally the images in one or more ways over a display device such as MOI 120.

In some embodiments, carried device 100 may comprise additional sensors, such as a thermometer, a gas detector, explosive sensor, or the like, and the view displayed over MOI 120 or over other display devices may also comprise indications to gasses, explosives, or the like.

It will be appreciated that further components of the system may comprise additional processors, for example the COI and LOI may comprise processors for executing further data integration such as integrating the relative locations of the marked points within the cavity with the absolute locations received from the GNSS, enhancing the models, and displaying the models and additional information.

Carried device 100 may also comprise an image capture device 123, such as a camera, a video camera, a GoPro® camera, a thermal camera, or the like.

Carried device 100 may comprise frame 107, which may have a base 126, for putting carried device 100 in a stable manner over a surface.

Scanner or measuring device 104 and image capture device 123 may be attached to a holder 118, having a handle 222, and vest clips 114, wherein holder 118 is connectable to frame 107.

Carried device 100 may comprise a GNSS rover 127, which is useful in determining the location of device 100 by communicating with GNSS base 124. If GNSS rover 127 has a line of sight to satellites the absolute location may be obtained with high accuracy, for example a few centimeters.

In some situations, for example in underground or closed cavities, there is no line of sight to satellites, therefore GNSS rover 127 is useless and only makes carrying device 100 less comfortable. In such situations, lock 110 may be used to release holder 118 from frame 110, leaving only holder 118 with handle 222, scanner or measuring device 104 and capture device 123.

In some embodiments, processor 116 may determine, for example upon receiving indications from IMU 108, that the system is stationary for at least a predetermined period of time. Processor 116 may then obtain using GNSS Rover 127 the absolute coordinates of the system. If GNSS rover 127 has line of sight to satellites the obtained location is known to be of high accuracy, for example up to 5 cm. In some embodiments, certain location providing systems may provide an accurate location without having a line of sight to satellites, for example by communicating with a base station located in an explored point.

Processor 116 or any other processor, such as a processor associated with MOI 120, LOI or COI may match the absolute locations obtained by GNSS Rover 127 and the locations within the point cloud as determined by scanner or measuring device 104. The correspondence may be performed for example by matching the time stamps of the scanner indicated points and the GNSS rover 127 coordinates, which should be identical or similar, for example taken within a predetermined time window such as 1 second. The points, with their absolute coordinates, may be displayed, for example over a display device of wearable item 106.

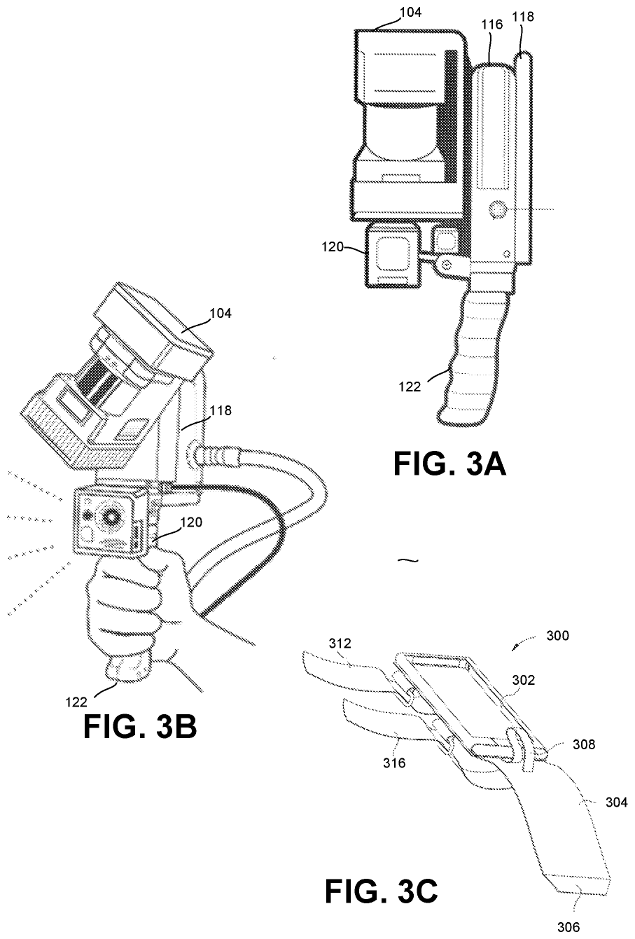

FIG. 3A shows a side view of carried device 100 without GNSS rover 127 and without frame 107, and FIG. 3B shows a user's hand holding the device by handle 222 with scanner 104 and capture device 123 attached to holder 118.

When holding carried device 100 by handle 222, a user can reach out his hand holding carried device 100 into an opening, such that scanner or measuring device 104 and capture device 123 can capture the structure and images of the opening. The user can then decide whether to advance into the opening or not.

In some embodiments, the user can attach carried device 100 to an adapted wearable item, such as a vest. Carried device 100 can be attached to the vest using vest clips 114.

Referring now to FIG. 3C, showing an illustration of an exemplary wearable item 106 being a wrist case for attaching MOI 120 to a user's wrist, in accordance with some embodiments of the disclosure.

Wearable case 300 may comprise compartment 302, having an open face corresponding in size to the size of the display of MOI 120. Wearable case 300 may also comprise strap 308 for attaching MOI 120 the case, and wider strap 304 for covering the display, so that it does not dazzle the user, does not get scratched, or the like. Strap 304 may comprise at its end a flap 306, which may be covered with a Velcro® patch, or the like,

Wearable case 300 may also comprise one or more straps to be tied around the user's wrist. For example, strap 312 and strap 316. In some embodiments, strap 316 may be tied in a more distal location than strap 312, and may thus be shorter than strap 312.

Wearable case 300 may hold MOI 120 within compartment 302. MOI 120 may be a computing platform with a display device, for example a smartphone having a display as large as possible which can still be comfortable on a user's wrist, for example a mobile phone of up to 7″ diagonal. The user can thus view on the display device the structure of the cavity and the user's route within the cavity, without holding an object in the user's hand. In some embodiments, an application or module executed by MOI 120 may render a display of the cavity structure and the user's route.

In some embodiments, instead of wrist wrapper 304, a chest display holder may be used, which holds a display device near the user's torso, such that the user only needs to lower his eyes to see the display. In further embodiments, the display device may be attached to a pair of glasses, to a helmet, or to any other device.

It will be appreciated that carried device 100, MOI 120 and data logger 128 may also be fitted on wearable items other than a vest or a wrist case, such as pants, a coat, a helmet or the like.

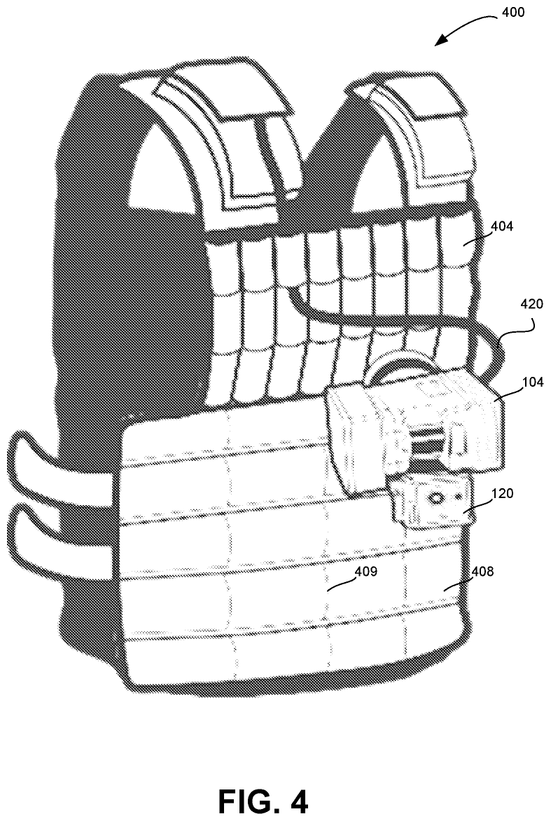

Referring now to FIG. 4, showing vest 400. Vest 400 may be any vest, such as a Modular Lightweight Load-Carrying Equipment (Molle) vest. Vest 400 may have one or more horizontal straps such as straps 408 sewn to vest 400 on their lower side and having separating seams 409, one or more straps having their top and/or bottom sides open such as straps 404, or the like.

Scanner or measuring device 104 can connect to holder 118, which can connect to one of straps 408 on the front side of vest 400. Thus, scanner or measuring device 104 and capture device 123 may be forward directed, according to the advancement direction of the user wearing vest 400. However, they may also be attached to the back side of the vest.

Data Logger 128 can be placed in any pouch and attached to vest 400 on either side. Scanner or measuring device 104 can connect to data logger 128 via cable 420 which may be secured by threading through any of straps 404.

Data logger 128 may also be connected to vest 400, for example by any standard pouch connectable to vest 400, on either side of vest 400, for example to any of straps 404 or 408, or otherwise harnessed to vest 400. In further embodiments, data logger 128 can be connected to a shoulder strap, such that the user can carry data logger 128 on its shoulder rather than connect it to vest 400.

It will be appreciated that further elements may be connected to vest 400, such as a pouch comprising a battery pack, or the like.

MOI 120 may be implemented as a mobile device, such as but not limited to a mobile phone, a tablet, or the like.

Referring now to FIG. 5, showing the control and data transfer between the system units, and the relevant protocols thereof.

Data from scanner or measuring device 104, including point cloud data as well as data from IMU 108 may be provided to data logger 128 for storage, using, for example cable communication. Similarly, data from image capture device 123 including captured images may be provided to data logger 128 also using wired communication. In some embodiments, a single cable may connect data logger 128 to scanner 104 and image capture device 123. The cable may connect, for example, to holder 118 to which scanner 104 and image capture device 123 may connect mechanically and electrically. It will be appreciated that the cable may also provide power from image capture device 123 to scanner 104 and to image capture device 123.

Images captured by image capture device 123 may also be provided to LOI 508 through wired communication, which may be established after the user exited the cavity, or is otherwise able to connect image capture device 123 and LOI 508.

Data logger 128 may provide information to and optionally receive commands from LOI 508 using Wi-Fi communication, when available.

Data logger 128 may provide information to and optionally receive commands from COI 504 using Wi-Fi communication, when available.

MOI 120 may communicate with LOI 508, data logger 128 and GNSS base 124 through Wi-Fi communication, when available.

GNSS base 124 and GNSS rover 127 may connect through any appropriate channel, such as a UHF antenna.

GNSS base 124 may communicate with MOI 120 using Wi-Fi communication.

It will be appreciated that the communication channels and protocols above are exemplary only, and other channels and protocols may be selected, as long as they enable receipt and storage of the data collected when the user traverses the cavity, and usage thereof at any later time by any required device.

Any of interface devices COI 504, LOI 508 and MOI 120 may display the cavity structure based on the point cloud, optionally with the user's route. The marked points with the associated absolute locations may be displayed as well. Upon pointing at a specific location, such as any of the marked points, an image captured by image capture device 123 at the point may be displayed, which shows the view as seen from the associated location.

The information from data logger 128 may also be transmitted over any communication channel such as Wi-Fi, cellular communication, RF, or the like to any other computing platform, such as a server, a desk top computer, a laptop computer, or the like.

Depending on the type of the communication channel, the data may be transmitted online when received by data logger 128 and/or image capture device 123, or only once the user and carried device 100 are out of the cavity and communication is enabled. The computing platform, which may be COI 504 or others may be used for displaying or investigating the structure obtained by scanning or measuring device 104.

The computing platform may be further used for projecting coordinates of locations of the cavity, for example the boundaries of the cavity onto the ground level, and displaying them with additional available data. The computations may be distributed between a number of computing platforms, which may or may not include COI 504, and computation products may be shared.

Prior to entering the cavity, GNSS base 124 may obtain accurate positioning information and communicate it to GNSS rover 127. This process may take some time, for example up to 40 minutes. Once the position is established, GNSS rover, if it has a line of sight to satellites may continue obtaining accurate positions and associated each such position with a time stamp, for synchronizing with a point cloud and with an IMU reading. Thus, the user exploring the cavity may stop from time to time, for example for 10 seconds, during which a point cloud is generated, one or more images may be taken, an accurate position is acquired, and all the data above is synchronized with a time stamp. If no line of sight exists, the absolute location may be assessed form the location at the entrance to the cavity and the IMU readings and processing thereof.

In some embodiments, instead of the wearable units, all components may be installed on a moving platform, such as a car, a motorized platform, a robotic platform, an animal back, or the like, which may be self-stirring, remotely controlled or remotely driven. The apparatus, comprising all components may then capture and process data as described, and may collect and store the data for example on a data logger and/or transmit the data to a remote location by a communication device using any protocol, such as Wi-fi, cellular, wired, or the like. The data may then be displayed at the remote site on a display device, such as a computer screen, a television, an LCD display, or the like. The displayed data may be used, automatically or manually, for further driving or stirring the platform.

### Experimental Results

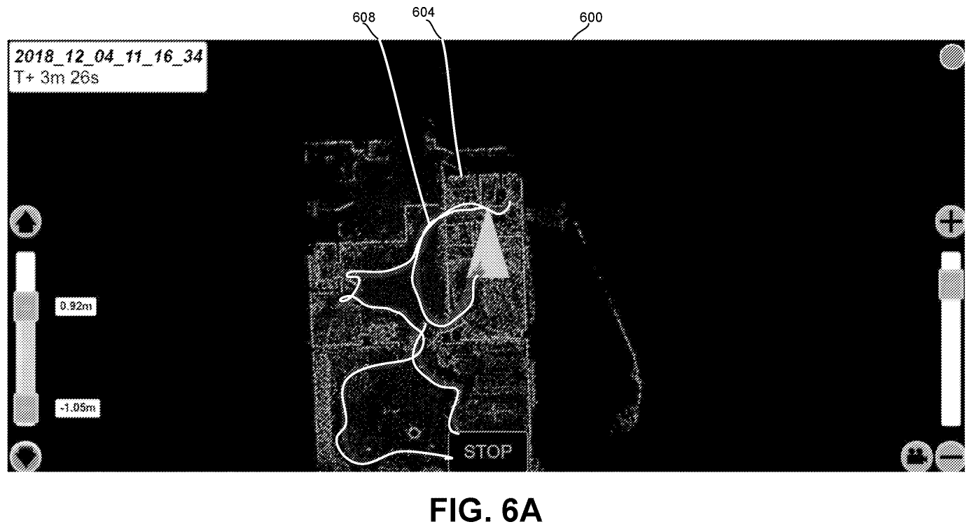

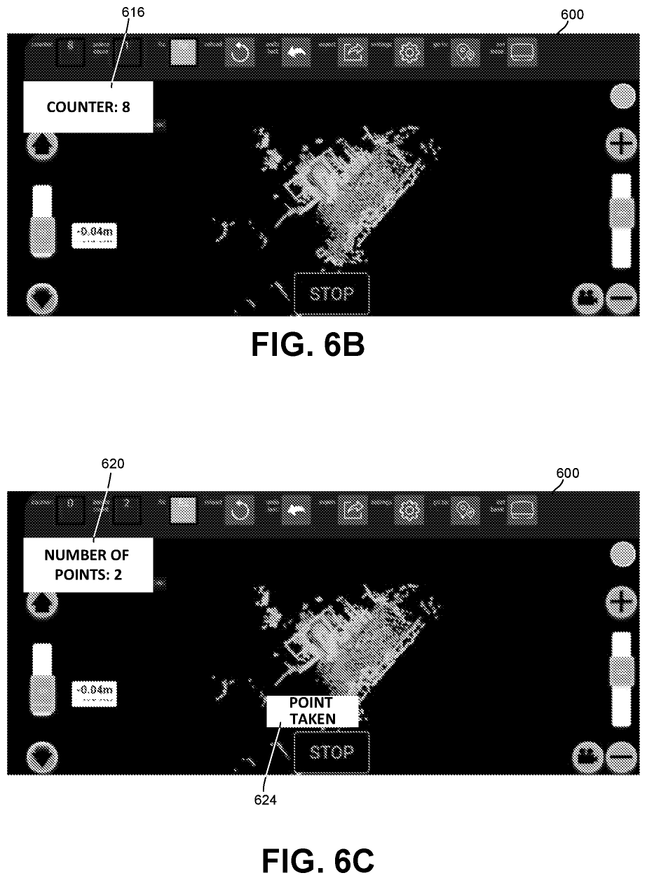

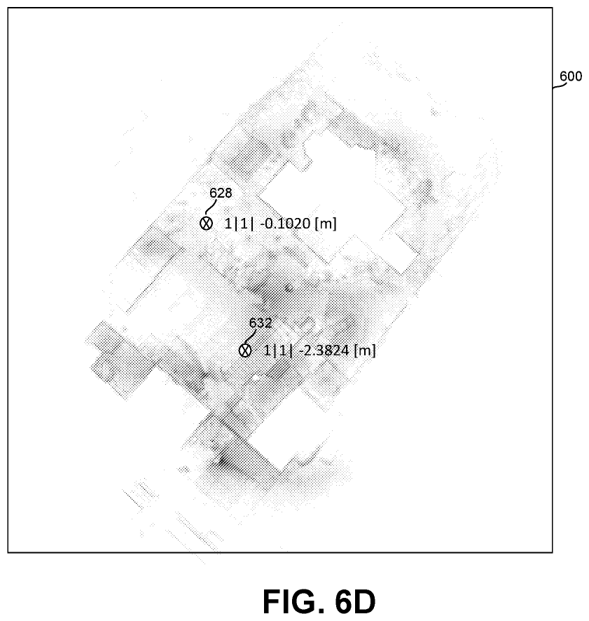

Referring now to FIG. 6A, showing an exemplary user interface 600 displaying a 2D model of a cavity structure, and the user's route therein, as may be displayed to a user over MOI 120 during exploration, or over COI 504 or LOI 508 during exploration or at a later time, in accordance with some embodiments of the disclosure. The cavity is shown in the form of a point cloud, wherein each wall or another scanned object is shown as a concentration of points such as 604, and the user's route is shown as path 608. The user can thus view the structure, and may know which areas have not been sufficiently explored, how to exit the cavity, or the like.

Referring now to FIG. 6B, showing user interface 600 while navigation, when the system has line of sight to satellites and after the user has stopped and the system has been stationary for some time, shorter than the predetermined period of time. Notification 616 is presented, displaying a count-down of the seconds until absolute coordinates are noted for the current location of the system. The coordinates may be obtained continuously, immediately as the user stopped, or after the predetermined period of time. Similarly, the location relative to the point cloud may be obtained at any of these points in time, as long as consistency is maintained.

Referring now to FIG. 6C, showing user interface 600 while navigation, after the user has stopped for the predetermined period of time. Notification 620 is presented, indicating that a point has been taken, and notification 624 indicates the number of points that have been taken during stops of the user.

Referring now to FIG. 6D, showing user interface 600 while displaying a model of a cavity, with marked points 628 and 632. For each such point its absolute coordinates, as received by GNSS rover 127 when it has line of sight to satellites is displayed as well. The model with the marked points thus enables to examine the access options to each such point and to other locations within the model. In some embodiments, further points may exist for which absolute coordinates may be available, optionally at lesser accuracy, since the coordinates are calculated based on the accurate coordinates of t marked points and IMU data. These points may also be displayed on the user interface with their coordinates. In some embodiments, the points with the less accurate coordinates may be marked differently from the points with the accurate coordinates, for example in a smaller font, lighter color, or any other less prominent manner.

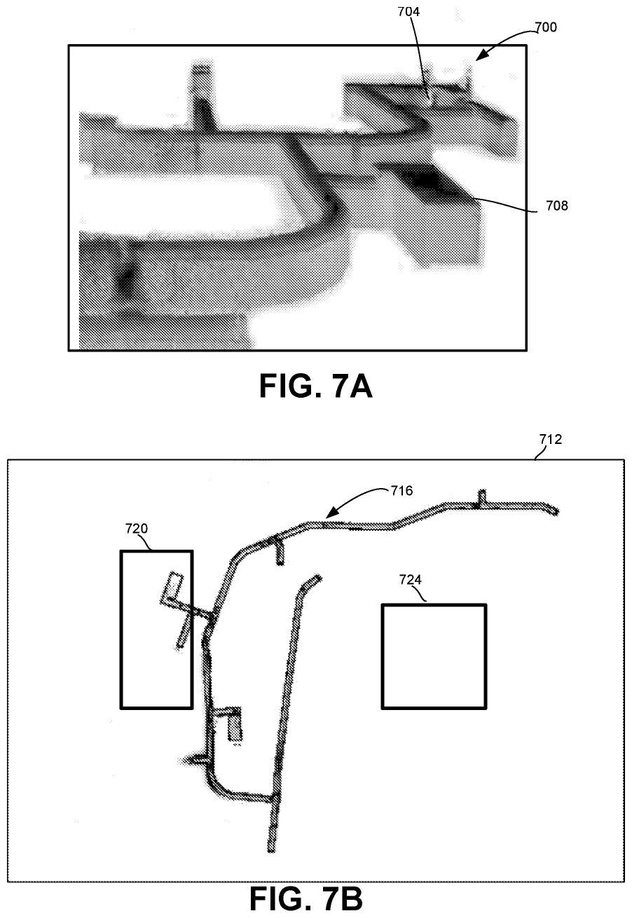

Referring now to FIG. 7A, showing an exemplary 3D model 700 of an underground tunnel system as obtained by the scanning device used by a user traversing the tunnel system, in accordance with some embodiments of the disclosure, The 3D model enables any manipulation, such as rotation, zoom, selecting a point of view within any of the cavity areas such as area 704, or the like.

Some of the areas, for example area 708 may have been obtained without the user going into a part of the cavity, but only reaching out his hand with carried device 100, such that the point cloud captures the shape of the area, and one or more images are taken.

When the user clicks on a point in the model, a 2D image obtained by image capture device at the location indicated by the point may be displayed. In some embodiments, a direction indicator may be presented over the model, showing the look direction of the camera when the image was taken.

In some embodiments, each point in the model may be associated with absolute coordinates, for example by adapting the relative coordinates collected by the IMU 108 to absolute coordinates in accordance with the closest marked point and the data obtained by IMU 108.

Referring now to FIG. 7B, showing a map 712 comprising a projection 716 of a model of a cavity such as an underground cavity, on the ground level, as well as buildings or other objects in the vicinity of the cavity, such as buildings 720, 724. A user wishing to drill at a specific location into the cavity can thus navigate on the ground surface using the map to that location, and drill exactly at the required location. Alternatively, the user can drill at another location above the cavity, and proceed within the cavity to the required location. As shown in map 712, the 3D cavity structure may be scaled and projected onto a two dimensional map, wherein the map can be used for planning penetration into the cavity, operations within the cavity or the like.

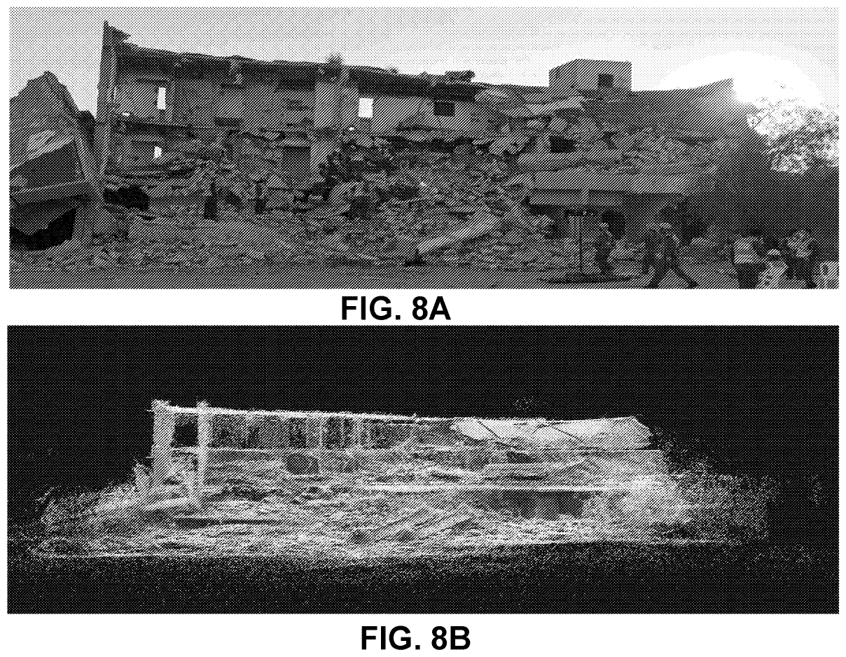

Referring now to FIG. 8A, showing an image of a side view of a demolished building, and FIG. 8B showing a side view of the 3D model of the same. The 3D model enables virtual traversing of any point in the building, including hidden cavities which a person could not get into but could reach out his hand, obtain a 3D structure as well as images, and thereby search for survivors or bodies. The 3D model enables intensive examination of the building and efficient planning of the next steps.

The system thus provides for extensive exploration and assessment of all types of cavities, with or without GNSS reception, regardless of the lighting conditions, and even if only a small opening is available to some parts.

The generated model and image enable planning of further traversals of the cavity, whether entering through the same entrance or a different one.

The system may be used hands-free, thus freeing the user's hands to other purposes, such as stabilization, protection, or the like.

In some embodiments, the components may be located on a moveable platform within the cavity. The scanning device and the IMU may transmit the sensed data to a computing platform, located for example outside or in the vicinity of the cavity. A processor associated with the computing platform may generate a 2D or 3D model and may present a view of the model to a user over a display device. The user may then transmit stirring instructions to the platforming accordance with the model.

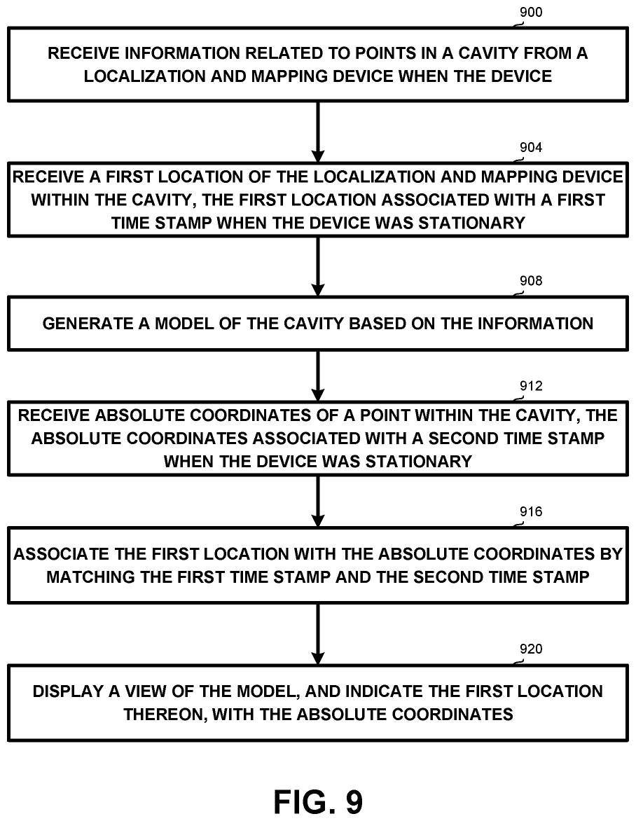

Referring now to FIG. 9, showing a a method that may be performed by a processor of the carried device a processor of additional device, or a combination thereof.

On step 900, information related to points in a cavity may be received, for example from a localization and mapping device. The points may describe parts of the cavity to which there is line of sight from the device. The information may be two dimensional or three dimensional.

On step 904, a first location may be received from the localization and mapping device, the first location describing a location of the device after the scanning device is stationary for at least a predetermined period of time, wherein the first location being associated with a first time stamp.

On step 908, a model of the cavity may be generated based on the received information. If the information is three-dimensional the model may be three dimensional as well, while two dimensional information may be used for constructing a two dimensional model.

On step 912, absolute coordinates may be received from a GNSS rover device, wherein the absolute coordinates describe the location of the device and associated with a second time stamp, when the device was stationary for at least the predetermined period of time.

On step 916, the first location and the absolute coordinates may be associated by matching the first time stamp and the second time stamp. Additionally or alternatively, the first location and the absolute coordinates can be matched within the space location using geometry considerations, such as IMU information, distance from other points, relation to an explored location, or the like.

On step 920, a view of the model may be displayed, wherein the first location is indicated, with the associated absolute location.

The figures illustrate the architecture, functionality, and operation of possible implementations of systems and devices according to various embodiments of the present disclosure. In this regard. It should also be noted that, in some alternative implementations, the functionality provided by the different components may be achieved using similar or other components, different materials or different dimensions without deviating from the principles of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Any combination of one or more components may be utilized.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed.

Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A system for mapping and navigating within a cavity lacking continuous satellite visibility, comprising:
a scanning device configured to generate a spatial model of the cavity using a simultaneous localization and mapping (SLAM) module;
a localization module configured to obtain absolute position information when available;
an inertial measurement unit (IMU) for providing data of motions taken by a user using the system;
at least one processor configured to:
receive the absolute position information from the localization module;
receive the spatial model generated by the SLAM module;
associate relative SLAM coordinates of the scanning device with the absolute position information;
update locations within the spatial model based on the motion data; and
a wearable device comprising a display device, the display device adapted to display a presentation of at least a part of the spatial model or a map of the cavity, and at least a part of a route taken by the user in the cavity.

2. The system of claim 1, wherein the wearable device is adapted to be secured to the user's wrist, thereby providing hands-free navigation within the cavity.

3. The system of claim 1, wherein said scanning device, said localization module, said IMU and said processor are provided in a housing.

4. The system of claim 1, wherein the housing is adapted to be carried by the user.

5. The system of claim 1, wherein the at least one processor is further configured to generate a map of the cavity.

6. The system of claim 1, wherein the at least one processor is further configured to project at least a portion of the spatial model or of a cavity map onto a surface-level coordinate system for planning physical access into the cavity.

7. The system of claim 6, wherein the access includes drilling, cutting, or breaching a location to a location within the cavity.

8. The system of claim 1, wherein the spatial model or a cavity map are available offline.

9. The system of claim 1, wherein the spatial model or a cavity map are used for further actions or explorations.

10. The system of claim 1 further comprising an image capture device adapted t capture images within the cavity.

11. The system of claim 11 wherein the display device is also adapted to display an image taken at a location within the cavity in response to indicating the location or being at the location.

12. A method for mapping and navigating within a cavity lacking continuous satellite visibility, comprising:
receiving the absolute position information from a localization module;
receiving a spatial model generated by a SLAM module;
associating relative SLAM coordinates of the scanning device with the absolute position information;
updating locations within the spatial model based on motion data of a user; and
displaying over a display device wearable by the user a presentation of at least a part of the spatial model and a part of a route taken by the user in the cavity.

13. The method of claim 12, wherein the wearable device is adapted to be secured to the user's wrist, thereby providing hands-free navigation within the cavity.

14. The method of claim 12, wherein said scanning device, said localization module, said IMU and said processor are provided in a housing adapted to be carried by the user.

15. The method of claim 12, further comprising generating a map of the cavity.

16. The method of claim 12, further comprising projecting at least a portion of the spatial model or of a cavity map onto a surface-level coordinate system for planning physical access into the cavity, the access including drilling, cutting, or breaching a location to a location within the cavity.

17. The method of claim 12, wherein the spatial model or a cavity map are available offline.

18. The method of claim 12, wherein the spatial model or a cavity map are used for further actions or explorations.

19. The method of claim 12, further comprising displaying an image captured at a location within the cavity when the location is indicated on the model or when a user is at the location.

20. A computer program product comprising a non-transitory computer readable medium retaining program instructions, which instructions when read by a processor, cause the processor to perform:
receiving the absolute position information from a localization module;
receiving a spatial model generated by a SLAM module;
associating relative SLAM coordinates of the scanning device with the absolute position information;
updating locations within the spatial model based on motion data of a user; and
displaying over a display device wearable by the user a presentation of at least a part of the spatial model and a part of a route taken by the user in the cavity.
